(19) United States
(12) Patent Application Publication
(10) Pub. No.: US 2016/0009024 A1
(43) Pub. Date: Jan. 14, 2016

(54) APPLICATOR FOR APPLYING PROTECTIVE COVERINGS TO ELECTRONIC DEVICE DISPLAYS

(71) Applicant: eShields, LLC, LA VERNE, CA (US)

(72) Inventor: ANDREW MASON, LA VERNE, CA (US)

(73) Assignee: eShields, LLC

(21) Appl. No.: 14/865,215

(22) Filed: Sep. 25, 2015

Related U.S. Application Data
(63) Continuation-in-part of application No. 14/484,625, filed on Sep. 12, 2014.
Application No. 14/484,625 is a continuation-in-part of application No. 61/876,935, filed on Sep. 12, 2013.

(51) Int. Cl. B29C 63/02; B29C 65/48; B29C 65/78; B29C 63/04

(52) U.S. Cl. CPC B29C 63/02; B29C 63/04; B29C 65/48; B29C 65/7841; B29C 2063/027; B29L 2007/008

(57) ABSTRACT

An applicator is provided for applying protective films to electronic device displays. The applicator includes a base, a screen protector, and a squeegee. The base includes a pocket for receiving an electronic device. The screen protector is affixed to the base so as to overlie an electronic device. The screen protector preferably includes three layers including a protective film, cap sheet, and back liner. Preferably, the back liner includes one or two tags which extend beyond the edge of said protective film for allowing one to manually peel the back liner from the protective film. The squeegee is provided for removing the back liner and for simultaneously affixing the protective film to an electronic device.

### RELATED APPLICATIONS

The present application is a continuation-in-part of co-pending U.S. patent application Ser. No. 14/484,625 filed on Sep. 12, 2014, which in turn is a continuation-in-part of U.S. Provisional Patent Application No. 61/876,935 filed on Sep. 12, 2013.

### BACKGROUND OF THE INVENTION

The present invention relates to protective coverings. More particularly, the present invention relates to protective coverings for the screen displays of electronic devices. Even more particularly, the present invention relates to an applicator for applying protective coverings to electronic device screens.

Portable electronic devices have proliferated in modern society. These devices include cellular telephones, digital music players, tablet computers, personal digital assistants, notebook computers and even electronic watches. Each of these devices typically has an electronic display in the form of a screen for displaying information. Often these screens are “touch” screens which act as a graphical interface.

Various attempts have been made to protect the electronic displays. For example, phone covers have been developed for covering all surfaces of a phone except for the display. The edges of the phone are protected from shock, scratches or the like. Moreover, these covers provide some protection to the screen by extending beyond the edge of the screen. Gorilla Glass® is a hardened glass which provides some additional protection compared to traditional glass. However, even this type of glass can break or scratch.

Translucent films have been developed for protecting an electronic display. An example of such a film protector is disclosed in U.S. Pat. No. 7,957,524 which describes a kit including a film, squeegee and liquid for applying the film to the screen of an electronic device such as a cellular telephone. These films provide excellent protection for the screen against scratching and impact shock. More recently, films have been developed which provide anti-bacterial properties.

Unfortunately, application of the translucent film to the display can be troublesome. Earlier films required that a liquid solution be applied to the screen prior to application of the film. The liquid solution activated the adhesive on the film by allowing the film to slide into its proper position and allow air bubbles to escape. Unfortunately, the use of the liquid solution was messy, annoying, and could void manufacturers warranties on the cellular telephones as the manufacturers were concerned that the liquid could interfere with the operation of the electronic device.

More recently, “dry” films have been developed which do not require a liquid solution to squeeze out bubbles. Unfortunately, even these dry films are difficult to install and prone to fingerprints forming under the shield adjacent to the electronic display.

U.S. Patent Application No. 2012/0211170 and U.S. Patent Application No. 2012/0211171 disclose applicators for applying shields to electronic displays. Unfortunately, even these applicators are difficult to use and prone to failure.

Accordingly, there is a need for an improved applicator for applying protective films to the displays of electronic devices.

Preferably, the improved applicator would be inexpensive to manufacture and easy to use.

Preferably, the improved applicator would firmly hold an electronic display in place while applying a protective film to the device's electronic display.

### SUMMARY OF THE INVENTION

The present invention addresses the aforementioned disadvantages by providing an improved applicator for applying protective films to electronic device displays. Preferably, the applicator is provided in a kit form which is packaged to include each of the elements for applying a protective film. The applicator includes a screen protector. The term “screen protector” is often used to refer to a single sheet of film which has been applied to an electronic device's display. However, herein the term “screen protector” is intended to refer to the protective film to be applied to an electronic device, as well as a back liner which covers the protective film's adhesive prior to application of the protective film to a display. More preferably, the preferred screen protector of the present invention includes three layers including a protective film, a back liner and a cap sheet.

The protective film is made of a clear plastic, preferably polyurethane, which is precut to cover the display of an electronic device such as a cellular telephone. The screen protector's back liner is a flexible sheet of material, preferably also clear plastic, which covers the adhesive surface of the protective film. The back liner may be adhered to the protective film using various adhesives known to those in the art. However, the back liner is loosely adhered to the protective film so as to allow the back liner to easily peel from the film layer while maintaining sufficient adhesive upon the protective film for the protective film to adhere to an electronic display. Meanwhile, the cap sheet loosely adheres and covers the protective film's upper surface so as to provide protection to the protective film. Again, the cap sheet is loosely adhered to the protective film so as to allow one to peelably remove the cap sheet from the protective film. In a preferred embodiment, the cap sheet is adhered to the protective film in a manner so as to have lesser adherence to the protective film at the end wherein the cap sheet is intended to first peel away from the protective film than at the opposite end of the protective film.

The applicator of the present invention further includes a base having an upper surface and a pocket formed into the base's upper surface. The pocket is sized to receive an electronic device and maintain the electronic device in a predetermined position and alignment with the electronic display positioned to face upwardly. Maintaining the electronic device in a proper position can be accomplished by sizing and shaping the pocket so as to snuggly receive the electronic device. Alternatively, various constructions such as pins or shoulders may be incorporated into the base's pocket to maintain the electronic device in a proper position and alignment. Preferably, the base includes a second pocket for receiving a squeegee.

The screen protector and its layers are described herein as having first and second ends. Furthermore, the applicator's base is described herein as having a first and second end. The applicator is constructed so that the screen protector's first end is affixed to the base's first end in a manner that positions the screen protector to overlie the base's pocket with the back liner adjacent to pocket; the protective film positioned above the back liner; and the cap sheet affixed above the protective film so as to sandwich the protective film between the back liner and cap sheet. Moreover, the cap sheet affixes to the base so as to position the protective film to overlie and align with the display of an electronic device that has been positioned within the base's pocket. In a preferred embodiment, the protective film and cap sheet include an edge portion which extends beyond the electronic display so as to also adhere to the base.

A preferred applicator includes a squeegee having a substantially flat bottom surface and a laterally extending bore which forms a slot. The slot is sized for receipt of the screen protector. The slot is constructed to angle relative to the squeegee's bottom surface at an angle of less than 90°. Preferably, the squeegee slot is angled relative to the squeegee's bottom surface at between 28° and 48°. The preferred angle between the squeegee's slot and the squeegee's bottom surface is 38°.

Alternative squeegees are acceptable. For example, virtually any construction including a straight edge may be utilized for application of the protective film to a display. For example, rectangular credit cards or other thin rectangular plastic constructions are acceptable for use as a squeegee. Preferred simple thin squeegees are less than ⅛ inch thick, and are rectangular with dimensions ½ inch -2 inches by 1 inch by 6 inches, depending upon the size of the protective film to be applied.

Preferably, the applicator's base, screen protector and squeegee are prepackaged within traditional packaging such as a box, sleeve or plastic wrapping. Within the packaging, the screen protector is affixed to the base, and the squeegee is positioned with the base's second pocket.

To apply the protection film to an electronic device, the base is removed from the packaging. The squeegee is removed from the base's second pocket. The screen protector, which overlies the base's first pocket, is folded backwardly more than 90° and an electronic device is placed within the base's first pocket with the electronic device's display positioned to face upwardly. While folded back, the screen protector is projected into the squeegee's slot in a manner that maintains the squeegee's bottom surface parallel to the electronic device, and the squeegee is slid downwardly while receiving the screen protector until the squeegee's bottom surface engages the base. As a result of the screen protector bending backwardly, the protective film peels away from the screen protector's back liner. Thereafter, the squeegee is slid across the base's upper surface and the electronic device's display so as to cause the back liner to peelably disengage from the protective film while simultaneously forcing the protective film to engage and adhere to the electronic device's display. Advantageously, the squeegee will also simultaneously squeeze out air bubbles between the protective film and electronic device display. Once the squeegee has completely slid across the electronic device, the back liner has been caused to peel away from the protective film.

Thereafter, an individual removes the cap sheet from the protective film by simply peeling the cap sheet from the protective film which has been affixed to an electronic device.

Preferably, the cap sheet is peeled away from the protective film at an end wherein the adhesive provides less adhesion than the other end. This change in adhesion can be accomplished by those skilled in the art. For example, lesser or more adhesive may be applied between the cap sheet and protective film at their respective ends so as to cause a greater adhesion at one end of the cap sheet than the other. Alternatively, different adhesives having different adhesive properties may be employed to vary the adhesion between the protective film and cap sheet. Once the cap sheet has been removed, the electronic device can be removed from the base's pocket for use with a now protected display.

Thus, it is an object of the present invention to provide an applicator for applying protective films electronic devices.

Moreover, it is an object of the present invention to provide an applicator which can be packaged in kit form for use by non-professionals to apply electronic devices at their homes or businesses.

It is still an additional object of the present invention for providing an applicator which properly aligns and applies a protective film upon an electronic device display which simultaneously removes bubbles.

Other features and advantages of the present invention will be appreciated by those skilled in the art upon reading the detailed description which follows with reference to the attached drawings.

### BRIEF DESCRIPTION OF THE DRAWINGS

FIG. 1 is a perspective view of the applicator of the present invention;

FIG. 2 is a perspective view of the applicator of the present invention illustrating insertion of an electronic device into the base's pocket;

FIG. 3 is a perspective view of the applicator of the present invention illustrating the folding back of the screen protector;

FIG. 4 is a perspective view of the applicator of the present invention illustrating the insertion of the screen protector into the squeegee's slot;

FIG. 5 is a perspective view of the applicator of the present invention illustrating the insertion of the screen protector into the squeegee's slot until the squeegee has engaged the applicator's base;

FIG. 6 is a perspective view of the applicator of the present invention illustrating the squeegee and screen protector having been folded back away from the face of an electronic device and upper surface of the base;

FIG. 7 is a perspective view of the applicator of the present invention illustrating the squeegee being slid across the face of an electronic device and upper surface of the base to remove the screen protector's back liner;

FIG. 8 is an additional perspective view of the applicator of the present invention illustrating the squeegee being slid across the face of an electronic device and upper surface of the base to remove the screen protector's back liner;

FIG. 9 is a perspective view of the applicator of the present invention illustrating the back liner having been removed from the protective film;

FIG. 10 is a perspective view of the applicator of the present invention illustrating the cap sheet being removed from the protective film;

FIG. 11 is a perspective view of the applicator of the present invention illustrating the cap sheet having been removed from the protective film;

FIG. 12 is a perspective view of the applicator of the present invention illustrated holding an electronic device with a newly applied protective film;

FIG. 13 is a perspective view an electronic device with a newly applied protective film;

FIG. 14 is a cut away view illustrating the back liner peeling from the protective film;

FIG. 15 is a close-up cut away view of the applicator in FIG. 14 illustrating the back liner peeling from the protective film;

FIG. 16 is a perspective view of the screen protector of the present invention illustrating its three components including a cap sheet, protective film, and back liner;

FIG. 17 is a top perspective view of a second embodiment of the applicator of the present invention;

FIG. 18 is a bottom perspective view of the applicator illustrated in FIG. 17;

FIG. 19 is a front perspective view of the applicator illustrated in FIG. 17 with the screen protector folded down;

FIG. 20 is a front perspective view of the applicator illustrated in FIG. 17 illustrating the folding back of the screen protector and the insertion of an electronic device into the base's pocket;

FIG. 21 is a front perspective view of the applicator illustrated in FIG. 17 illustrating a cleaning of the electronic display prior to application of a protective film;

FIG. 22 is a front perspective view of the applicator illustrated in FIG. 17 illustrating the manual manipulation of the flap to peel back the back liner from the protective film;

FIG. 23 is a front perspective view of the applicator illustrated in FIG. 17 illustrating the application of the protective film to the electronic device by sliding a squeegee upon the screen protector so as to remove the back liner;

FIG. 24 is a front perspective view of the applicator illustrated in FIG. 17 illustrating the removal of the back liner from the protective film;

FIG. 25 is a front perspective view of the applicator illustrated in FIG. 17 illustrating the initial peel of the cap sheet from the protective film;

FIG. 26 is a front perspective view of the applicator illustrated in FIG. 17 illustrating the peeling and removal of the cap sheet from the protective film;

FIG. 27 is a front perspective view of the applicator illustrated in FIG. 17 illustrating the cap sheet having been peeled and removed from the protective film, but the electronic device not released from the base;

FIG. 28 is a front perspective view of the applicator illustrated in FIG. 17 illustrating the screen protector's tab being severed from the protective film; and

FIG. 29 is a front perspective view of the applicator illustrated in FIG. 17 illustrating the electronic device's removal from the applicator's base.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

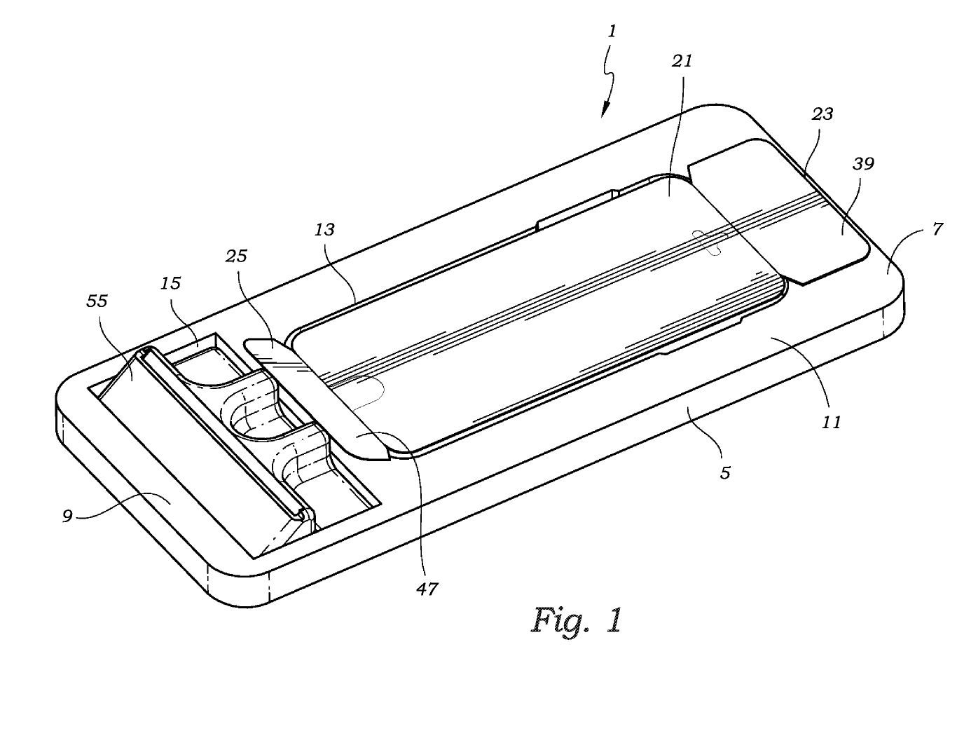

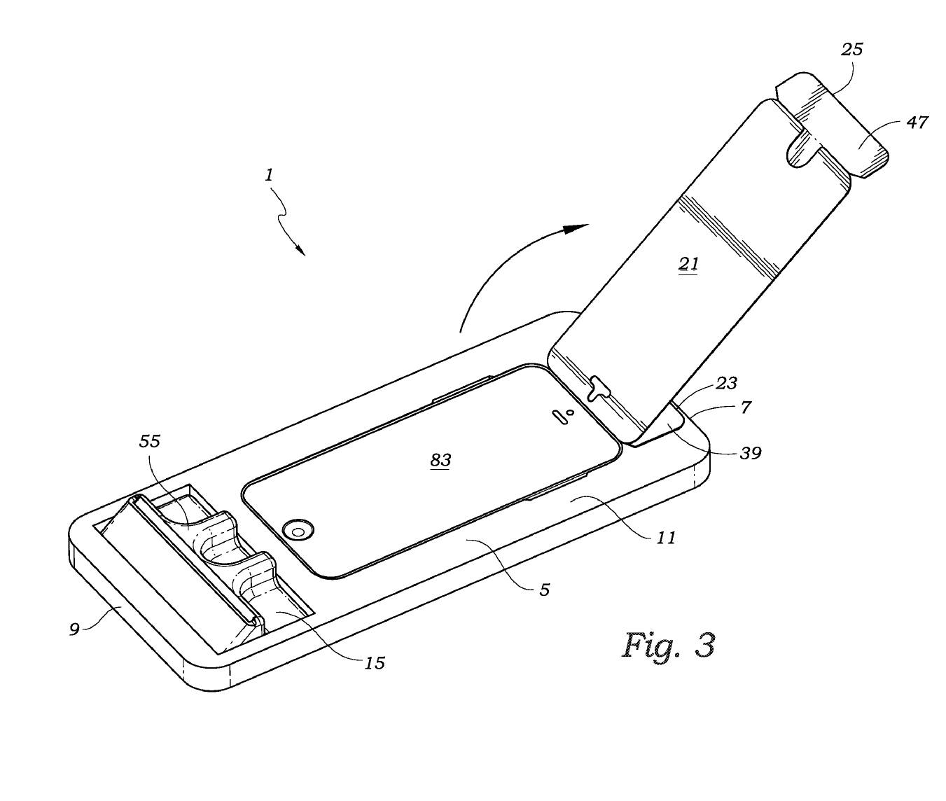

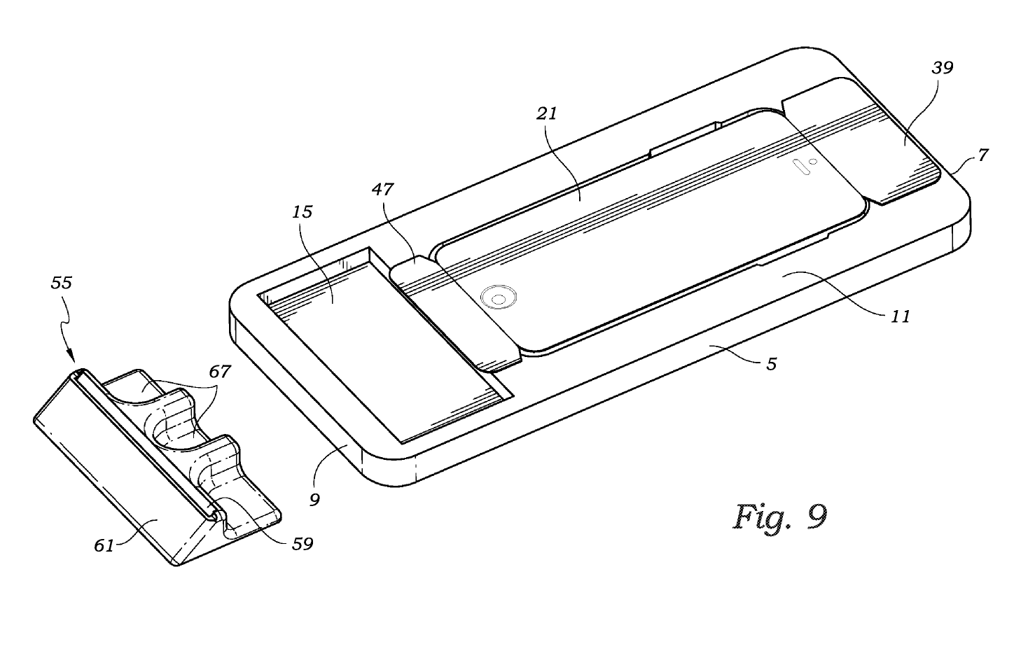

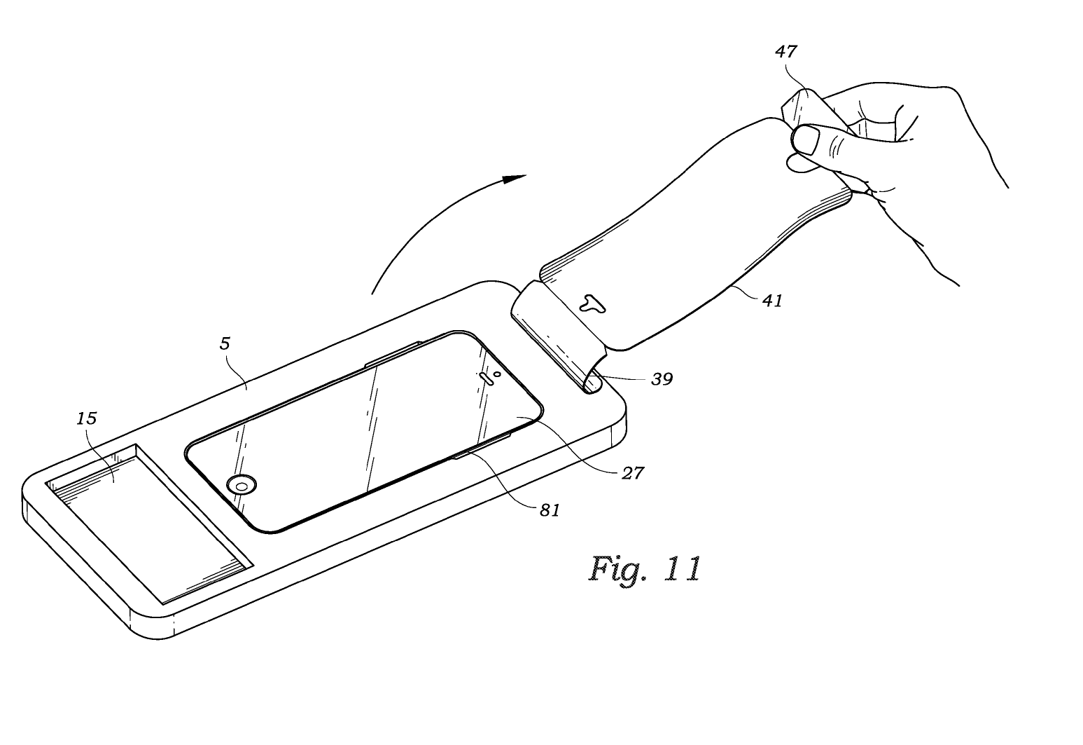

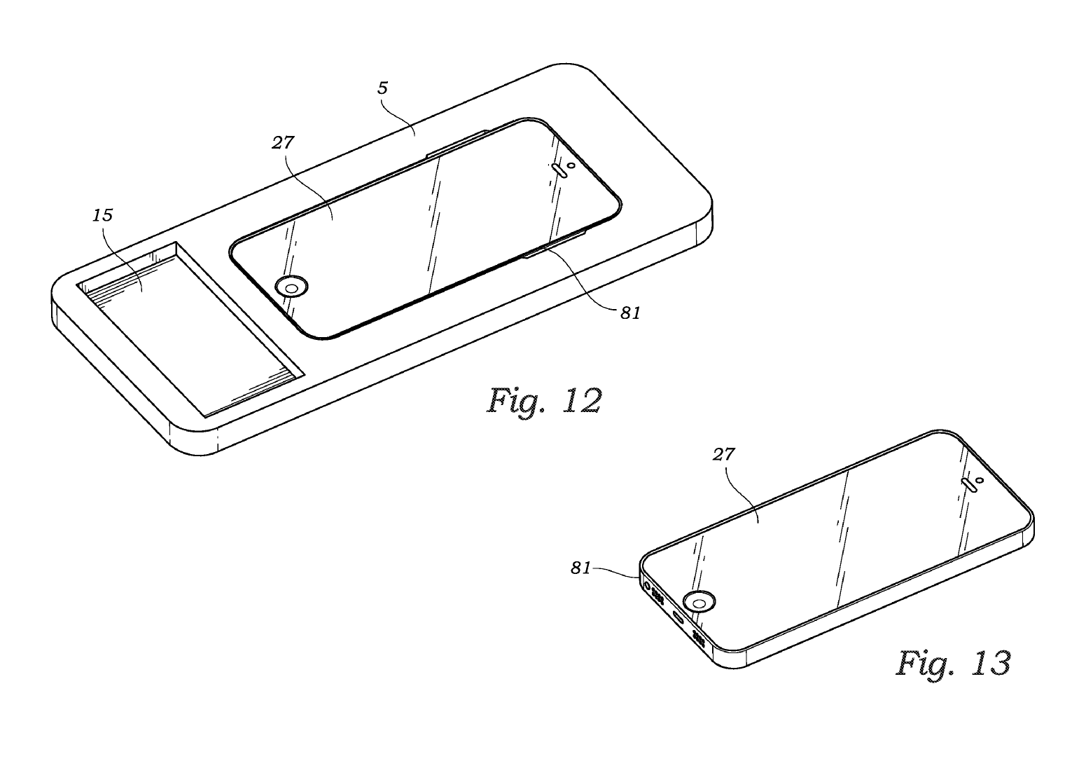

With reference to FIGS. 1-16, the present invention is a first preferred applicator 1 for applying a protective film 27 to an electronic device's display 83. Preferably the applicator 1 is provided in a kit form including each of the components in a prepackaged format. The applicator's primary components include a base 5, a screen protector 21, and a squeegee 55.

As illustrated in FIGS. 1-12, the base 5 is preferably elongate to form a first end 7, a second end 9, and an upper surface 11. The base 5 further includes a first pocket 13 formed into the base's upper surface 11. The first pocket 13 may be constructed in various shapes and sizes depending on the electronic device 81 intended to be placed in such pocket. Preferably, the base 5 also has a second pocket 15 for receiving a squeegee 55. The base 5 is preferably made of foam which is sufficiently soft to accept an electronic device 81 into its first pocket 13 without scratching, marring or otherwise damaging the electronic device while also affixing an electronic device in place so as to prevent movement of the phone. To this end, preferably the base's first pocket 13 is sized to provide a slight press-fit to an electronic device within the pocket. The base may be manufactured by various manufacturing techniques known to those skilled in the art. In a preferred embodiment, the base is manufactured in three layers including a bottom layer of foam, a second middle layer of dye cut foam wherein cavities have been created to form the first pocket 13 and second pocket 15. Preferably, the base has an upper layer of polyvinyl chloride to provide a smooth rigid surface.

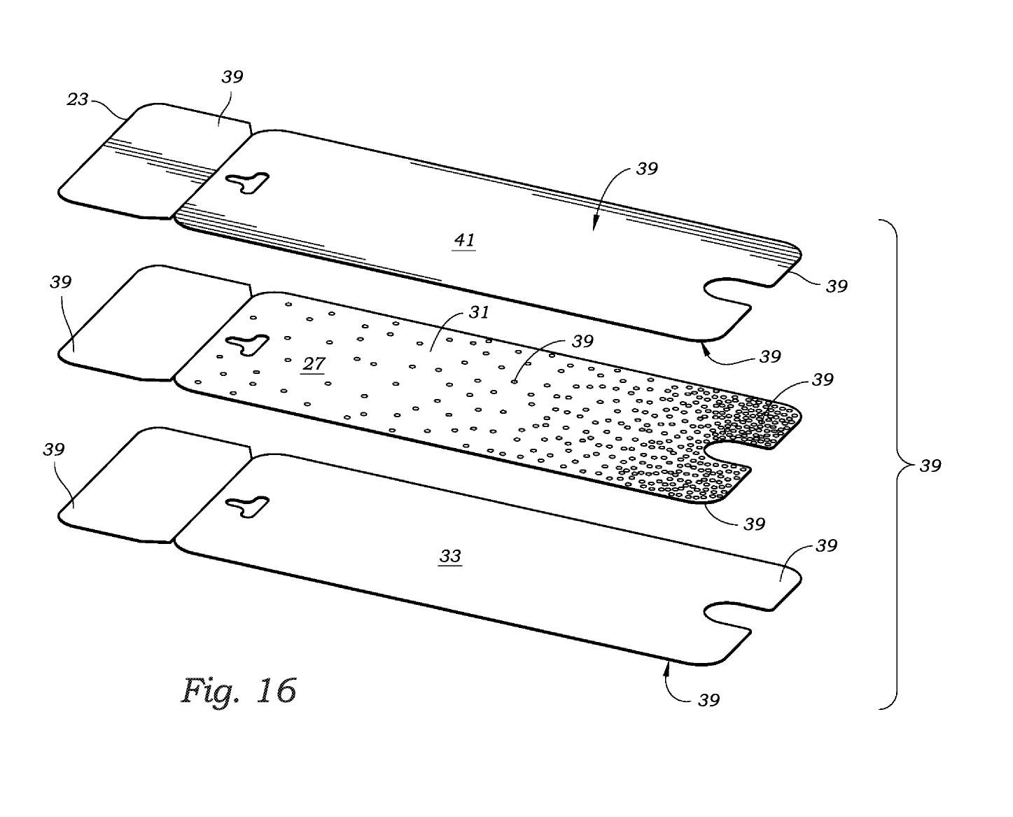

The applicator's screen protector 21 preferably includes three layers of clear plastic. As illustrated in FIG. 16, the screen protector 21 includes a protective film 27 sandwiched between a back liner 33 and a cap sheet 41. The protective film 27 is preferably made of polyurethane which may include various additives such a for ultraviolet (UV) protection or bacteriacidal capabilities. The protective film 27 has a lower adhesive side 29 intended to affix to an electronic device display 83 and an upper exterior surface 31 for protecting an electronic device. The screen protector's back liner 33 has a lower side 37 and an adhesive side 35 which loosely adheres to the protective film's adhesive side 29. The third layer of the protective film 27 is the cap sheet 41. The cap sheet 41 has a lower adhesive side 43 which loosely adheres to the protective film's upper exterior surface 31. The cap sheet 41 also includes an exterior side 45.

The screen protector's first end 23 is affixed to the base's first end 7 so as to allow the screen protector to overlie the base's first pocket 13. As illustrated in FIGS. 1-12, the screen protector 21 is affixed to the base by providing one or more layers of the screen protector with an edge portion 39 which extends to cover and adhere to the base's upper surface 11 at its first end 7. Where the back liner 33 or protective film 27 extends to engage and adhere to the base 5 at the base's first end 7, preferably each of these layers include “kiss cuts”. The kiss cut through the protective film allows the portion of protective film, which is intended to adhere to an electronic device display 83, to separate from the protective film's tab 39. Similarly, the back liner 33 includes a kiss cut so as to allow the back liner to crack and tear from the screen protector's tab 39. As understood by those skilled in the art, a “kiss cut” is a cutting of material, typically through a dye cut, to extend partially but not all the way through a material. Here, it is preferred that the protective film 27 include a kiss cut which extends 95% of the way through the protective film layer. However, it is preferred that the back liner 33 is cut completely from the screen protector's edge portion 39 so as to allow it to more easily separate and peel from the protective film 27. Furthermore, the screen protector's tab 39 may include alignment holes for properly aligning the screen protector upon the base 5 during the manufacturing process.

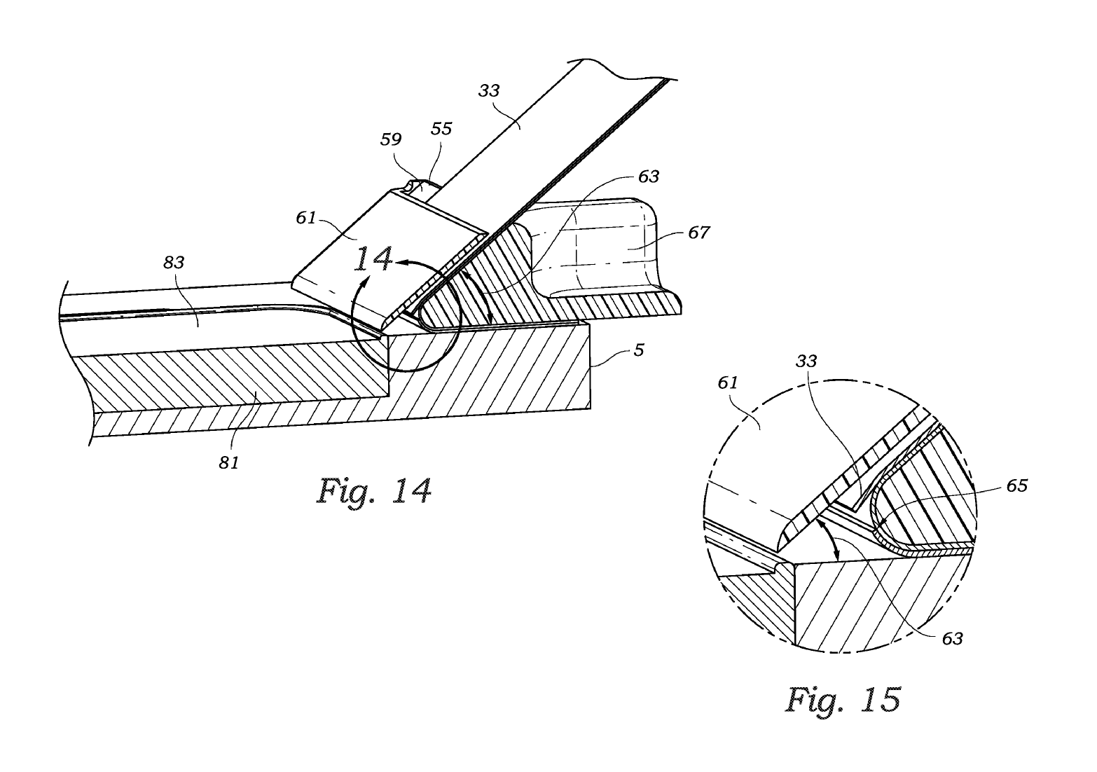

With reference to FIGS. 14 and 15, the applicator 1 of the present invention further includes a squeegee 55 which is preferably positioned within the base's second pocket 15. The squeegee 55 has a substantially planar bottom surface 57. In addition, the squeegee 55 includes a bore which laterally extends to form a slot 59. The squeegee's slot 59 is angled relative to the squeegee's bottom surface 57. Furthermore, preferably the squeegee 55 includes an angled front side 61 forming the front side of the slot 59. Moreover, preferably the bottom surface 57 includes a rounded edge where the squeegee's bottom surface interfaces with the slot 59. As illustrated in FIGS. 14 and 15, the squeegee slot 59 is angled relative to the squeegee's bottom surface 57 at an angle 63 of less than 90°. Preferably, the squeegee slot is angled relative to the squeegee's bottom surface at between 28° and 48°, with the presently preferred angle at 38°. The squeegee 55 may include finger recesses 67 sized for receiving a person's fingers to facilitate manipulation of the squeegee.

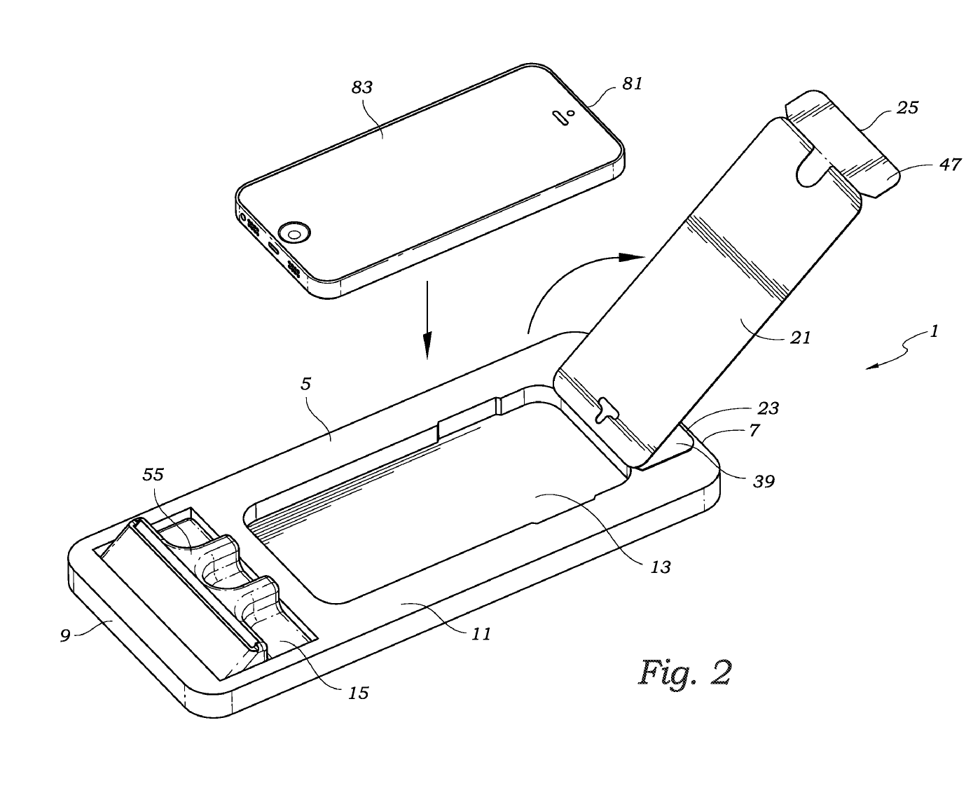

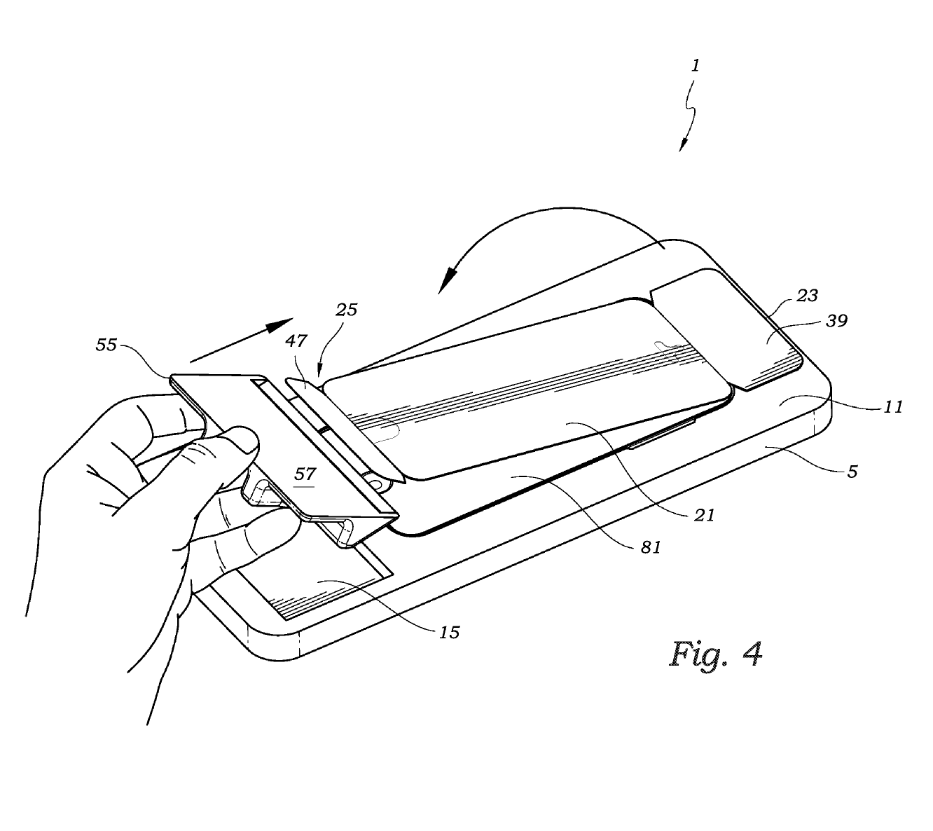

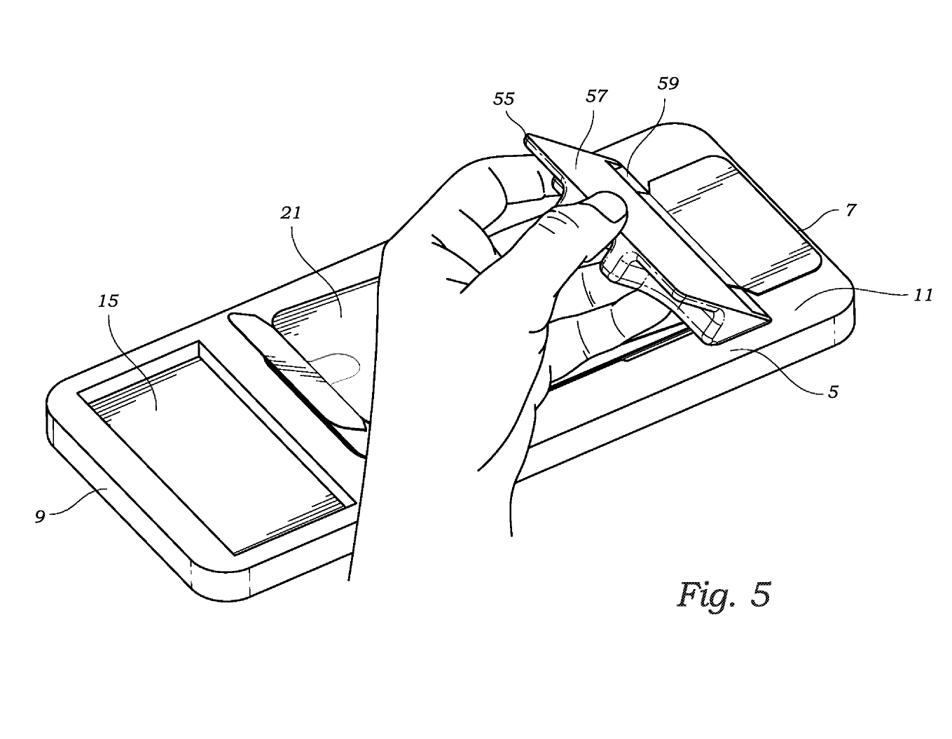

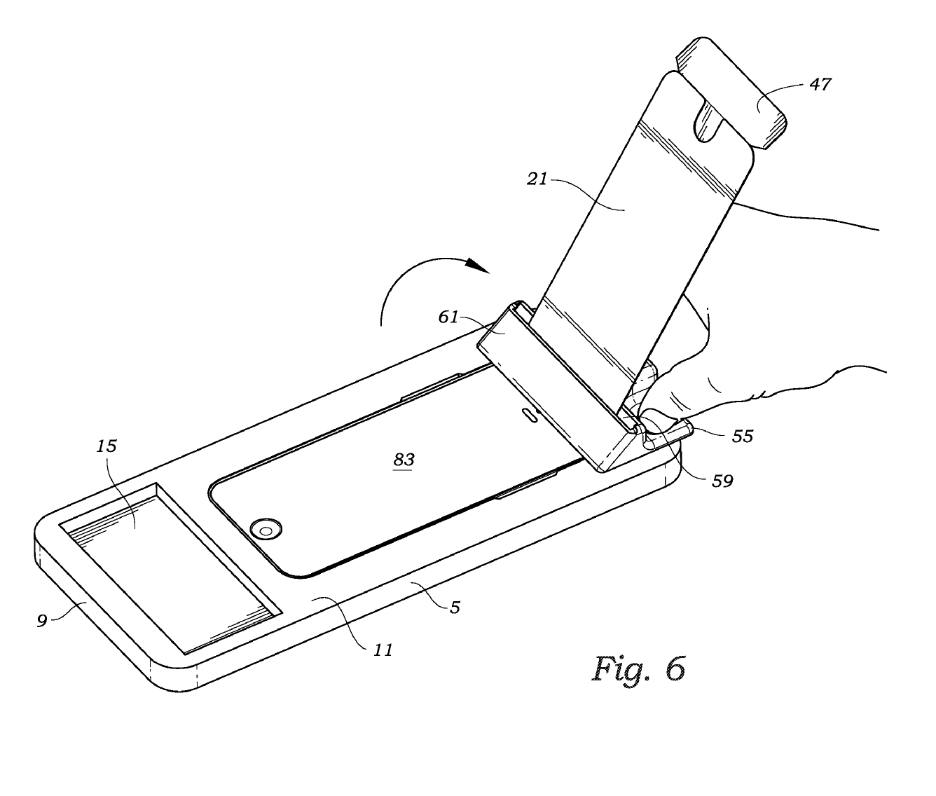

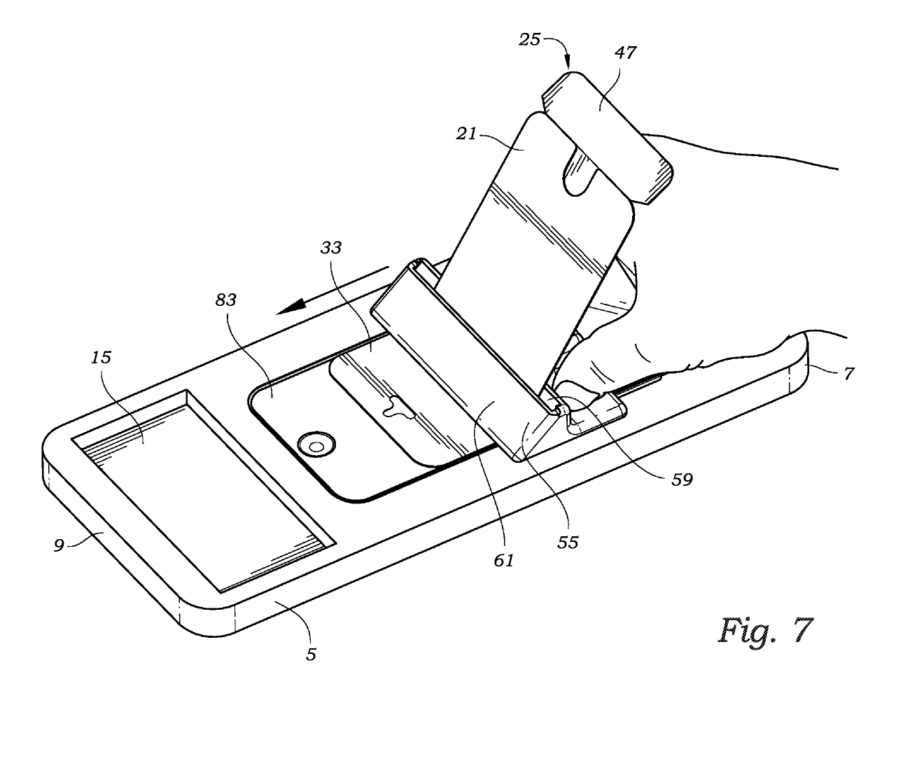

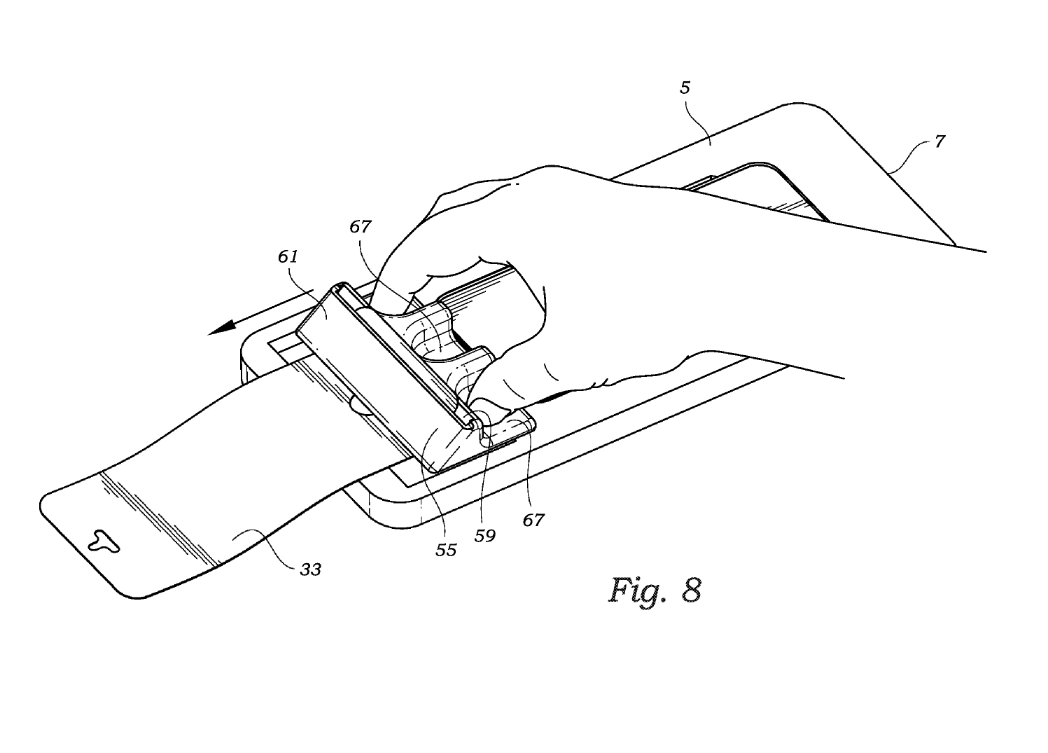

As illustrated in FIG. 2, to apply a protective film 27 to an electronic device display 83, the screen protector 21 is folded backwardly to allow insertion of an electronic device 81 into the base's first pocket 13. The electronic device is positioned within the first pocket 13. Thereafter, as illustrated in FIGS. 4 and 5, the screen protector's second end is inserted and made to pass through the squeegee's slot 59. Importantly, the screen protector must be inserted into the squeegee's slot 59 so as to allow the squeegee's bottom surface 57 to engage the base's upper surface 11. For example, the screen protector 21 can be folded backwardly so as to not cover the electronic device 81 and the squeegee can be slid downwardly with the slot receiving the screen protector until the squeegee's bottom surface engages the base's upper surface 11 (see FIG. 5). Alternatively, as illustrated in FIG. 4, the screen protector may be positioned to overlie the base's first pocket 13, and the squeegee slot is made to receive the screen protector 21 with the squeegee positioned upside down with its bottom surface 57 facing upwardly. As illustrated in FIG. 6, once the squeegee 55 has slid the length of the screen protector 21 so as to engage the base at its first end 7, the screen protector 21 is folded backwardly. As illustrated in FIGS. 14 and 15, when the screen protector 21 has been folded back in accordance with the angle 63 between the squeegee's bottom surface 57 and slot 59, the screen protector's back liner 33 is made to crack and peel from the protective film 27. Thereafter, as illustrated in FIGS. 7 and 8, the squeegee 55 is slid across the base's upper surface 11 and the electronic device's display 83 so as to cause the back liner 33 to peel away from the protective film 27. Advantageously, the squeegee also forces out any bubbles between the protective film 27 and the electronic device's display 83. Once the squeegee has completely slid across the electronic device, the base liner 33 has been forced to peel away completely from the protective film 27 leaving the protective film securely adhered to the electronic device 81.

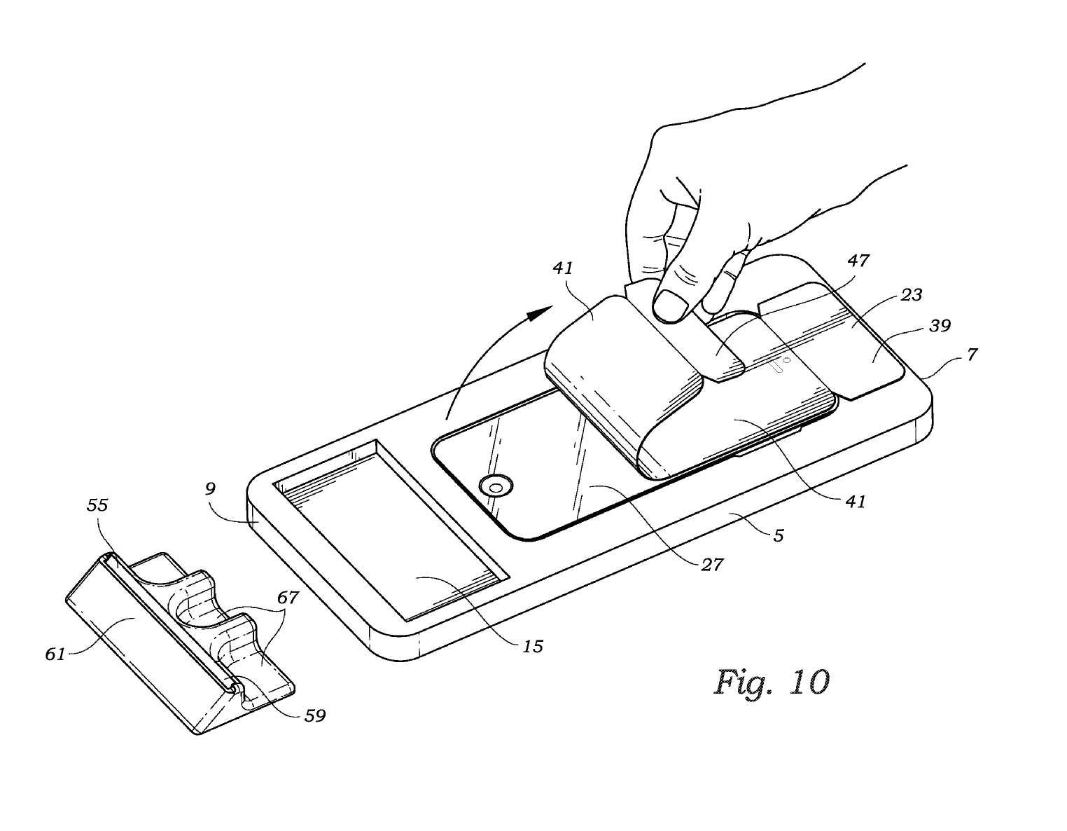

With reference to FIGS. 10-12, once the back liner has been removed from the protective film, the cap sheet 41 is removed from the protective film by simply peeling one end of the cap sheet 41 away from the protective film 27 until the cap sheet has been completely removed. To facilitate its removal, preferably the cap sheet 41 includes a tab 47 located at the screen protector's second end 25 which provides one with the ability to firmly grip the cap sheet for its removal. As illustrated in FIG. 16, preferably the cap sheet 41 is adhered to the protective film 27 with an adhesive 49 which provides less adhesion between the cap sheet 41 and protective film 27 at the end where one first grasps the cap sheet 41 to affect its removal from the protective film. The change in adhesion may be accomplished by various means known to those skilled in the art including the use of lesser or more adhesive at different locations or the use of different adhesives between the protective film and cap sheet. (See FIG. 16). Preferably, the adhesion, as measured by pull strength between the protective film 27 and cap sheet 41, is between 10%-90% at one end of the screen protector as compared to the other end. More preferably, the adhesion is 30%-50% at one end of the screen protector as compared to the other. Moreover, it is preferred that the difference in adhesion changes in at least one gradient, and more preferably in a plurality of gradients, and still more preferably gradually and uniformly from one end of the screen protector to the other. This difference in adhesion is advantageous so that adhesion is reduced at the end wherein the cap sheet is first peeled away from the protective shield so as to prevent pulling the protective film 27 away from the electronic device 81.

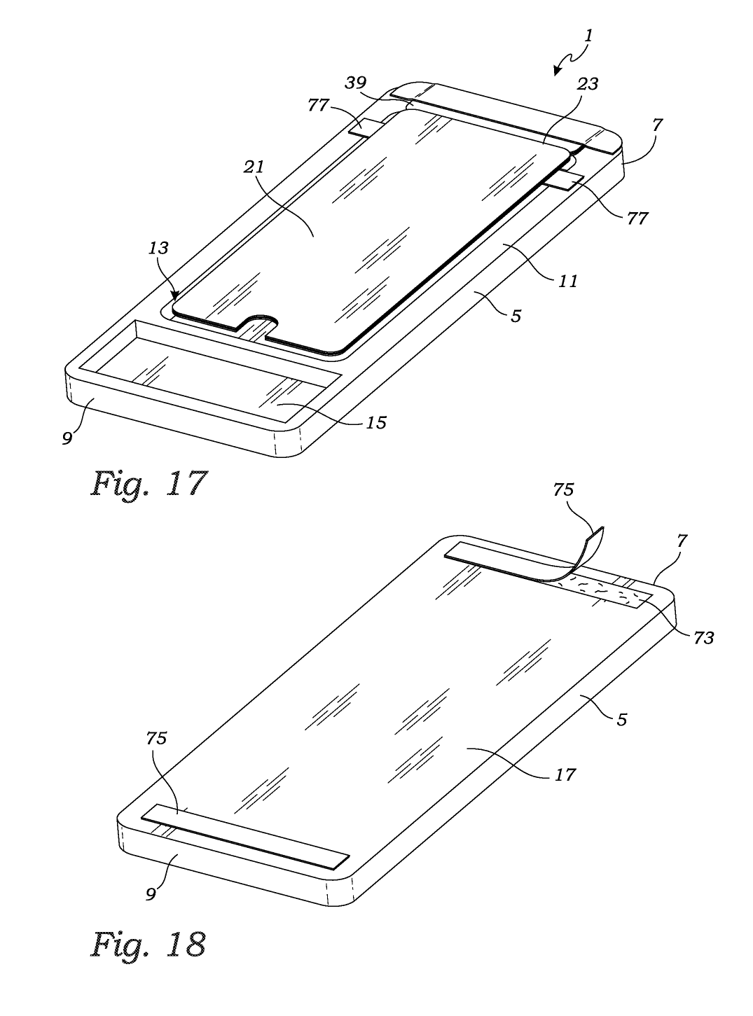

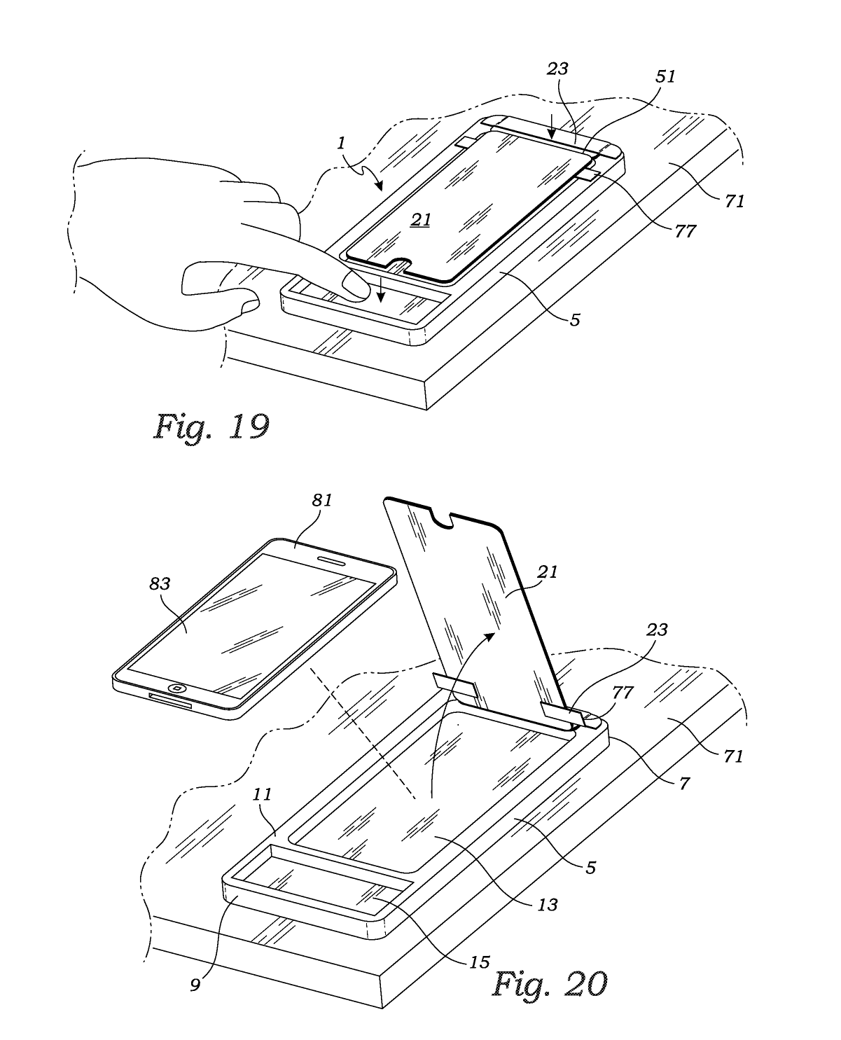

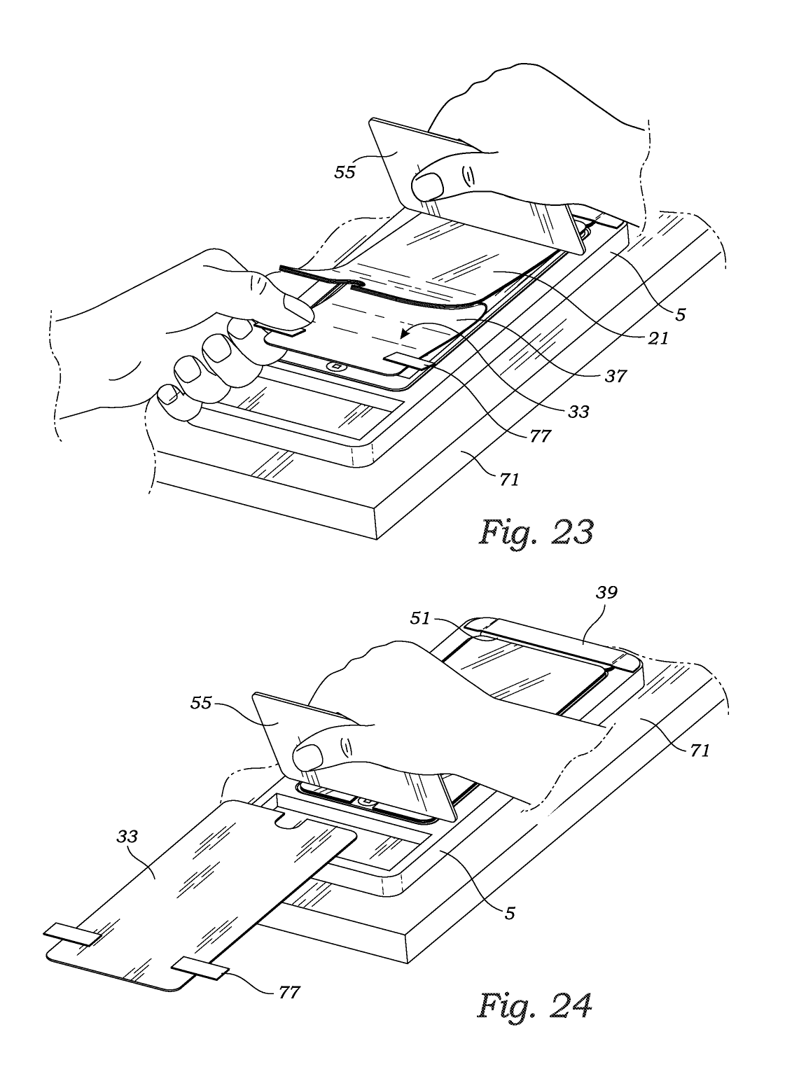

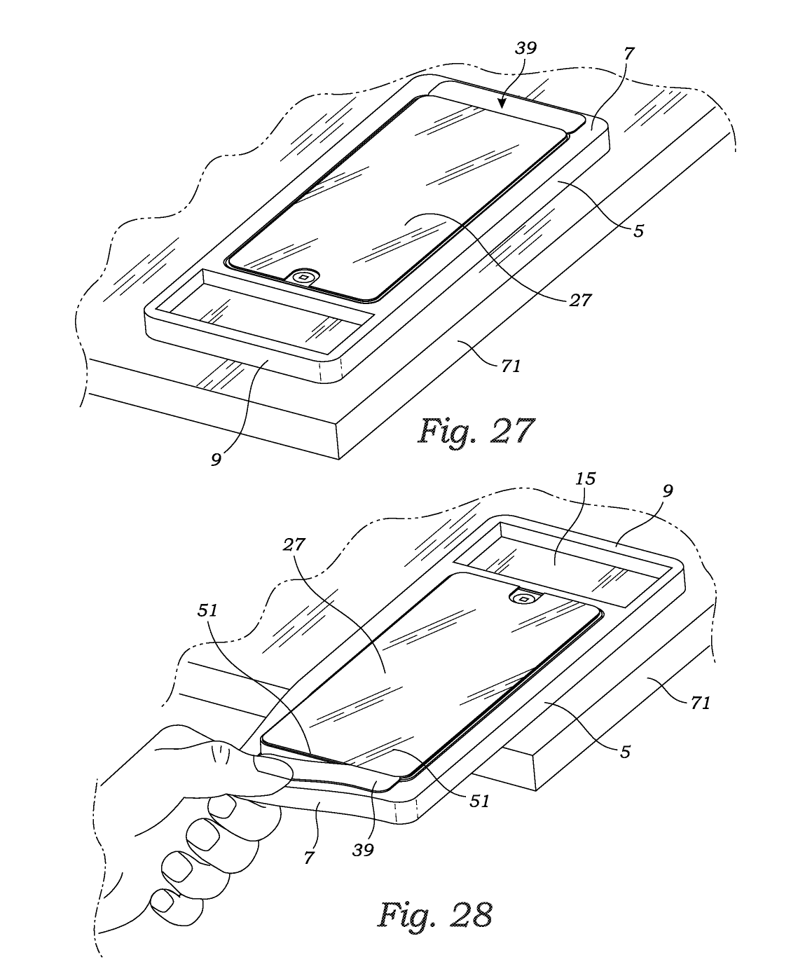

FIGS. 17-29 illustrate a second preferred applicator kit 1 for applying a protective film 27 to an electronic device's display 83. Like the applicator kit illustrated in FIGS. 1-16, the applicator kit's primary components include a base 5, a screen protector 21, and a squeegee 55 (Seen in FIGS. 23 and 24). Again, the base is preferably elongate to form a first end 7, a second end 9, an upper surface 11, and a bottom surface 17. The base 5 includes a first pocket 13 sized for receiving an electronic device 81 into the base's upper surface 11. The base may be constructed to include a second pocket 15 for receiving a squeegee 55. However, it is not necessary that the base include a second pocket 15, particularly where the squeegee is a thin rectangular “card” construction as illustrated in FIGS. 23 and 24. Preferably the base 5 is made of a flexible foam material which is sufficiently soft to accept an electronic device 81 into its first pocket 13 in a slightly press-fit arrangement. As illustrated in FIG. 18, preferably the base's bottom surface 17 includes an adhesive 73 covered by a removable strip 75. The adhesive is advantageous for affixing the base's bottom surface 17 to a flat surface 71 such as the top of a table, as illustrated in FIGS. 19-29. Moreover, as explained in greater detail below, it is preferred that the base 5 is sufficiently soft so as to have some flexibility.

The second embodiment's applicator kit 1 has a screen protector 21 which includes three layers of plastic, including the clear protective film 27 which adheres to the electronic device's display 83. The screen protector's three layers include a back liner 33 having a lower side 37 and an adhesive side 35 which loosely adheres to the protective film's adhesive side 29. In addition, the screen protector 1 includes a cap sheet 41 which has a lower adhesive side 43 which loosely adheres to the protective film's upper exterior surface 31. Unlike the embodiment illustrated in FIGS. 1-16, preferably the back liner 33 includes one or more tags 77 which extend beyond the edge of the protective film 27 and which are located adjacent the base's first end 7. In a preferred embodiment illustrated in FIGS. 17-24, the back liner 33 includes two tags 77 positioned on opposite sides of the back liner near the base's first end 23.

The screen protector's first end 23 is affixed to the base's first end 7 so as to overlie the base's first pocket 13. The screen protector 21 includes a tab, also referred to as an edge portion, 39 which extends to cover and adhere to the base's first end 7. This edge portion 39 may include one or more layers of the screen protector. Preferably, both the protective film 27 and cap sheet 41 extend beyond the first pocket 13 to engage and adhere to the base's upper surface 11. For the embodiment illustrated in FIGS. 17-29, it is preferred that the back liner layer 33 is not adhered to the base's upper surface 11. Moreover, it is preferred that the protective film layer 27 include a kiss cut which extends partially through the protective film, and more preferably extends approximately 95% of the way through the protective layer so as to allow it to more easily separate and peel from the base 5.

With reference to FIGS. 23 and 24, the applicator kit includes a squeegee 55. For the embodiment illustrated in FIGS. 17-27, the squeegee 55 may be constructed as a thin rectangular card which may or may not be sized to fit within the base's second pocket 15. The rectangular card may be constructed of various dimensions. However, it is preferred that at least one edge of the rectangular card 55 is longer than the width of an electronic display 83 and protective film 27 so as to apply uniform pressure to the protective film 27 as it is applied to an electronic device 81.

With reference first to FIG. 18, a preferred method of applying a protective film 27 to a display 83 includes removing strip covers 75 from an adhesive 73 underlying the base 5. As illustrated in FIGS. 23-27, the base 5 is then adhered to a planer surface 71 such as a table. Preferably the adhesive is sufficiently strong as to maintain the base 5 in place upon the table 71 during application of the protective film to an electronic device. However, it is preferred that the adhesive is sufficiently weak so as to allow easy manual removal of the base from the flat surface when the application of the protective film to the electronic device is complete.

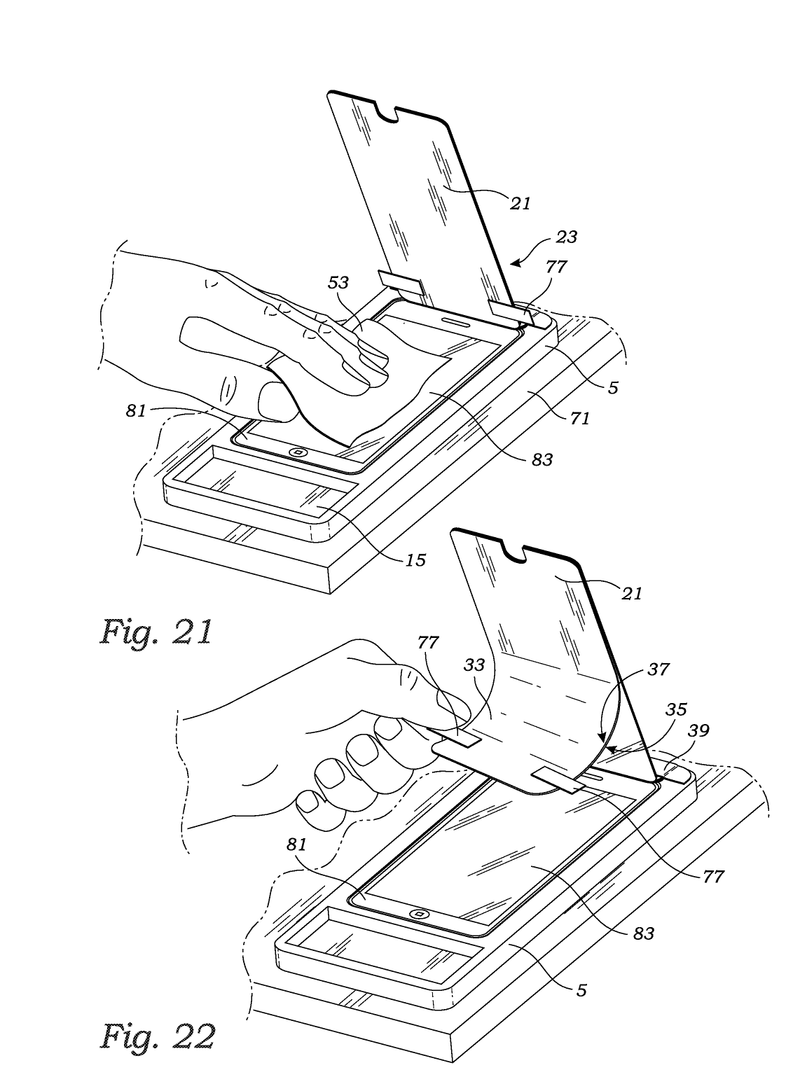

Once the base 5 is properly positioned on a flat surface, an electronic device 81 is positioned within the base's first pocket 13, as illustrated in FIG. 20. The electronic device's display 83 is then cleaned, as illustrated in FIG. 21. Thereafter, the screen protector's back liner 33 is peeled partially from its first end by pulling tags 77 away from the protective film layer 27. As illustrated in FIGS. 23 and 24, the squeegee 55 is then slid the length of the screen protector so as to cause the back liner 33 to peel away from the protective film 27, while forcing the protective film 27 against the electronic device's display 83. Advantageously, sliding the squeegee 55 against the screen protector 21 also forces out any bubbles between the protective film 27 and the electronic device's display 83.

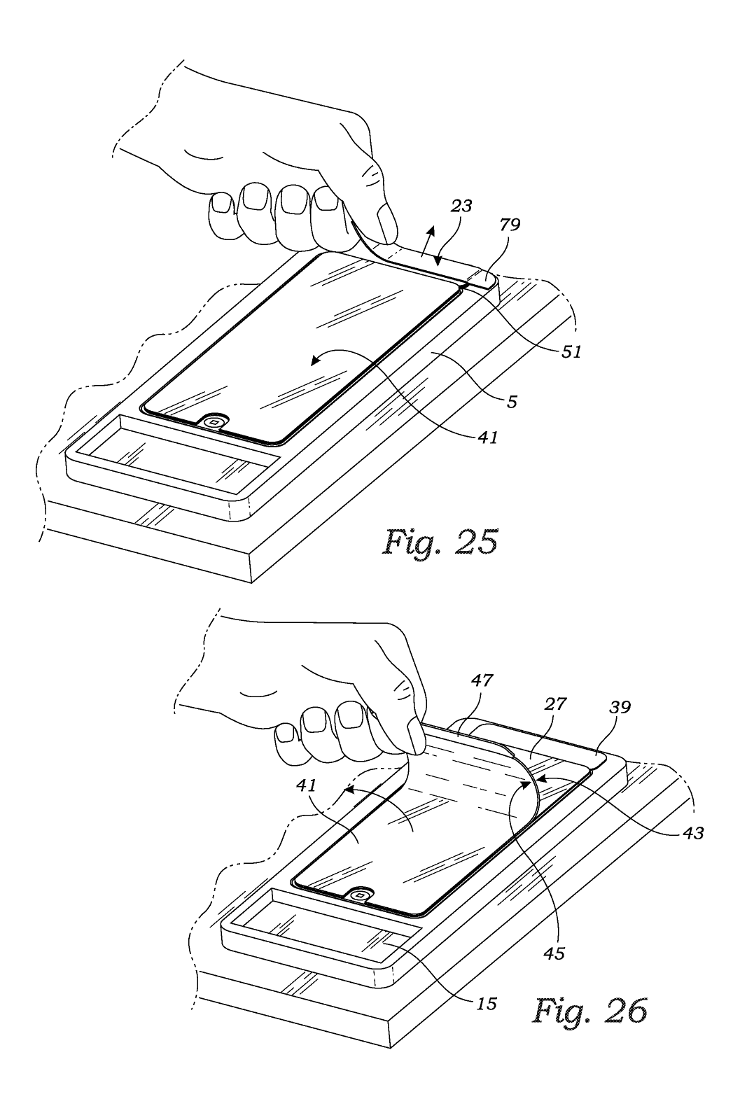

With reference to FIGS. 25 and 26, once the back liner 33 has been removed from the protective film 27, the cap sheet 41 is removed from the protective film by simply peeling one end of the cap sheet away from the protective film until the cap sheet has been completely removed. As illustrated in FIG. 25, the screen protector may include a supplemental flap 79 which maintains the cap sheet 41 engaged to the first end of the base 5. If this is the case, the flap 79 is peeled away and removed from the base 5 so as to allow one to peel the cap sheet 41 from the protective film 27. As described in greater detail below, preferably the cap sheet 41 is adhered to the protective film 27 with an adhesive that provides less adhesion at the end where one grasps the cap sheet to affect its removal from the protective film than the cap sheet's opposite end. Preferably, the adhesion is 30-50% at one end of the screen protector as compared to the other. Even more preferably, the adhesion changes in a plurality of gradients to provide at least three different strengths of adhesion between the cap sheet and protective film.

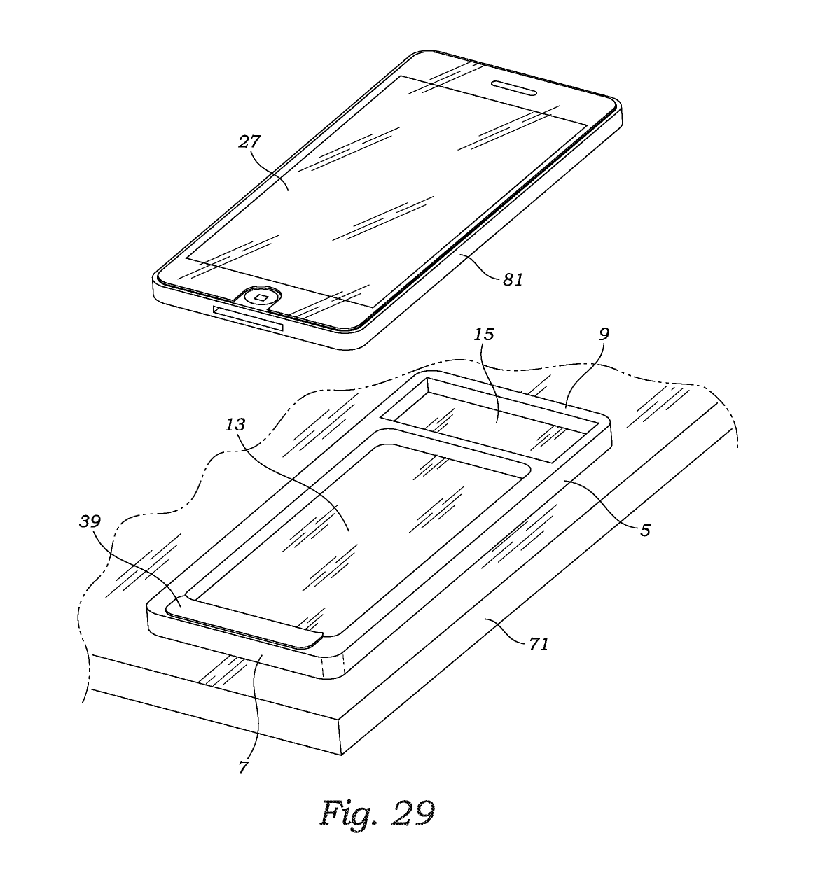

With reference to FIGS. 28 and 29, to complete application of the protective film 27 to the electronic device's display 83, the protective film's tab portion 39 is severed from the rest of the protective film at the kiss cut 51. Since the base 5 is preferably made of a soft foam material, this can be accomplished by moving the base 5 to the edge of a table 71 and flexing the base's first end 7 downwardly so as to tear the tab 39 from the rest of the protective film 27. Thereafter, the electronic device 81 can simply be popped out of the applicator's base 5 with the protective film 27 securely adhered.

As one skilled in the art will appreciate, different persons may refer to the same feature or component by different names. For example, any reference to “up” or “down”, or reference to a “first end” or “second end” is made for purposes of clarity.

While several particular forms of the invention have been illustrated and described herein, it will be apparent that various modifications can be made without departing from the spirit and scope of the invention. Therefore, it is not intended that the invention be limited except by the following claims. Having described my invention in such terms so as to enable persons skilled in the art to understand the invention, recreate the invention and practice it, and having presently identified the presently preferred embodiments thereof,

We claim:

1. An applicator kit for applying a protective film to an electronic device, the applicator kit comprising:
a base having a first end, a second end, an upper surface, and a pocket formed into said base's upper surface sized to receive an electronic device;
a screen protector having first and second ends, and said screen protector further including a cap sheet, a protective film, and a back liner, said protective film being loosely adhered between cap sheet and said back liner so that said cap sheet and back liner may be peelably removed from said protective film, said screen protector affixed to said base's first end so that said screen protector overlies said base's pocket with said back liner adjacent said pocket, said protective film sandwiched between said back liner and said cap sheet, and said cap sheet above both said back liner and protective film;
a squeegee having a straight edge so that movement of said squeegee across said base's upper surface from said base's first end to said base's second end would cause said back liner to peelably disengage from said protective film leaving said protective film adhered to an electronic device.

2. The applicator kit for applying a protective film to an electronic device of claim 1 wherein said back liner includes at least one tag which is adjacent to said first end and said tag extends beyond the edge of said protective film for allowing one to manually peel said back liner from said protective film.

3. A method of applying a protective film to an electronic device comprising the steps of:
providing an applicator kit wherein said applicator kit includes a base having a first end, a second end, an upper surface, and a pocket formed into said base's upper surface sized to receive an electronic device, a screen protector having first and second ends, and said screen protector including a cap sheet, a protective film, and a back liner, said protective film being loosely adhered between cap sheet and said back liner so that said cap sheet and back liner may be peelably removed from said protective film, said screen protector affixed to said base's first end so that said screen protector overlies said base's pocket with said back liner adjacent said pocket, said protective film sandwiched between said back liner and said cap sheet, and said cap sheet above both said back liner and protective film, a squeegee having a straight edge so that movement of said squeegee across said base's upper surface from said base's first end to said base's second end would cause said back liner to peelably disengage from said protective film leaving said protective film adhered to an electronic device;
placing an electronic device having a display within said pocket with its display faced upwardly;
sliding said squeegee across said base's upper surface from said base's first end to said base's second end to cause said back liner to peelably disengage from said protective film leaving said protective film adhered to an electronic device; and
peeling said cap sheet from protective film leaving said protective film adhered to said electronic device.

4. The method of applying a protective film to an electronic device of claim 3 wherein said back liner includes at least one tag which is adjacent to said first end and said tag extends beyond the edge of said protective film for allowing one to manually peel said back liner from said protective film, and said method further comprises the step of manually peeling said back liner from said protective film by pulling on said tag.
